(19) United States
(12) Patent Application Publication
(10) Pub. No.: US 2017/0143154 A1
(43) Pub. Date: May 25, 2017

(54) A WINDOW ASSEMBLY FOR A CONTAINER AND A METHOD OF ASSEMBLING THEREOF

(71) Applicant: TOP ELECTRIC APPLIANCES INDUSTRIAL LIMITED, Guangdong (CN)

(72) Inventors: Weizhong LI, Guangdong (CN); Yewu ZHONG, Guangdong (CN)

(21) Appl. No.: 15/319,424

(22) PCT Filed: Mar. 10, 2015
(86) PCT No.: PCT/CN2015/073958

§ 371 Date: Dec. 16, 2016

(30) Foreign Application Priority Data
Aug. 11, 2014 (CN) 201410390268.0
Aug. 11, 2014 (CN) 201420449060.7
Aug. 25, 2014 (CN) PCT CN2014/085079

(51) Int. Cl. A47J 27/21; B65D 25/54

(52) U.S. Cl. CPC A47J 27/21; B65D 25/54

(57) ABSTRACT

A window assembly (3) for a container (1), comprising a window unit (5) adapted to be inserted in a window opening (2) of a container body (4), the window unit (5) comprising an outer facing side (10), an inner facing side (12) and a profiled circumferential edge (14), wherein a portion of the circumferential edge (14) adjacent the outer facing side (10) comprises a rising ridge (16) which acts to limit insertion of the window unit (5) into the window opening (2). It also relates to a container (1) with such window assembly (3), and the method of assembling such window assembly (3) with the container (1).

### TECHNICAL FIELD

The invention relates to a window assembly for a container and a method of assembling thereof. Particularly but not exclusively, the invention relates to a window assembly for an electrical appliance such as a kettle.

### BACKGROUND ART

A window such as a window gauge is commonly arranged at liquid containers or electrical liquid containers such as kettles so as to allow the content to be visible by the users. Although containers equipped with windows of various designs are available in the market, efforts have been made to continually improve the appearance and the configuration of such windows so as to allow the containers to be not only aesthetically pleasing, convenient and safe to use, but also easy and less expensive to manufacture and to assemble.

In addition, various transparent or translucent materials such as glass or plastics have been used to manufacture these windows. Nevertheless, the use of plastic windows in liquid containers raises some safety and health in the mind of the public. More specifically, there is a concern that toxic chemicals such as bisphenol A may be released from the plastics material of the window into the liquid content particularly at high temperature, which may be potentially harmful to consumers' health.

### DISCLOSURE OF INVENTION

### Technical Problem

It is therefore an object of the present invention to overcome or ameliorate at least one of the disadvantages of the prior art, or to provide a useful alternative.

The above object is met by the combination of features of the main claims; the subclaims disclose further advantageous embodiments of the invention.

One skilled in the art will derive from the following description other objects of the invention. Therefore, the foregoing statements of object are not exhaustive and serve merely to illustrate some of the many objects of the present invention.

### SOLUTION TO PROBLEM

### Technical Solution

In a first main aspect, the invention provides a window assembly for a container. The window assembly comprises a window unit adapted to be inserted in a window opening of a container body, the window unit comprising an outer facing side, an inner facing side and a profiled circumferential edge, wherein a portion of the circumferential edge adjacent the outer facing side comprises a rising ridge which acts to limit insertion of the window unit into the window opening. The window assembly may be push or snap fitted into the window opening of the container from outside of the container thereby negating the need to access the interior of the container when assembling the window unit with the container.

In a second main aspect, the invention provides a liquid container comprising a container body having a window opening adapted to receive a window assembly according to the first aspect.

In a third main aspect, the invention provides a method of inserting a window assembly into a window opening of a container. The method comprises the steps of providing a window unit according to the first aspect; and inserting the inner facing side of the window unit into the window opening so that insertion of the window unit into the window opening is limited by the rising ridge.

### ADVANTAGEOUS EFFECTS OF INVENTION

### Advantageous Effects

The present invention is advantageous in that it provides a window assembly for a container which can be easily assembled with the container, is aesethically pleasing, and can be manufactured at reduced cost when compared to prior art arrangements.

The summary of the invention does not necessarily disclose all the features essential for defining the invention; the invention may reside in a sub-combination of the disclosed features.

### BRIEF DESCRIPTION OF DRAWINGS

### Description of Drawings

Preferred embodiments will now be described, by way of example only, with reference to the accompanying figures, in which the same reference numerals refer to like parts throughout the figures unless otherwise specified, and in which:

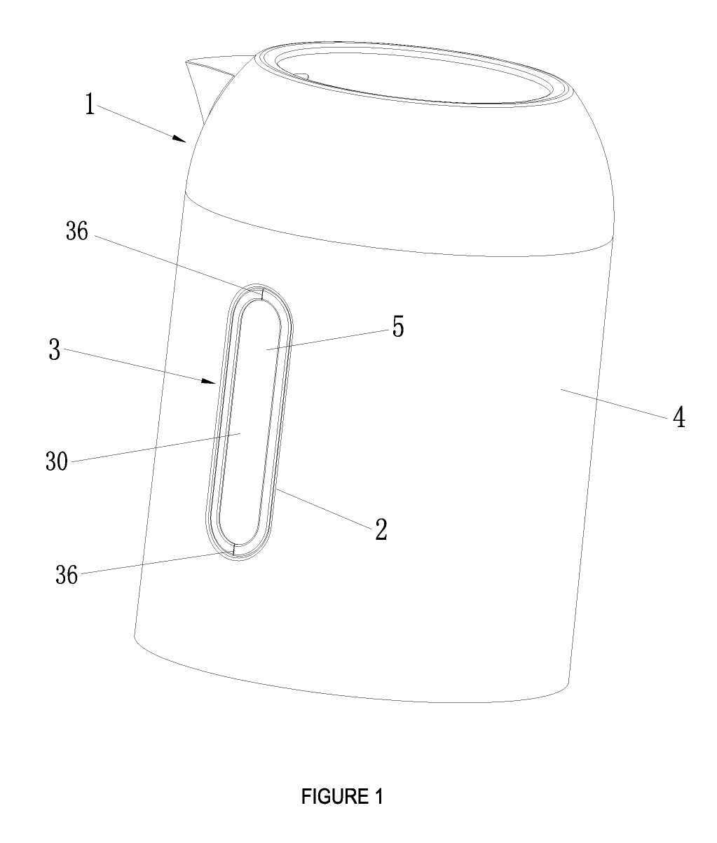

FIG. 1 is a perspective view of a kettle having a window assembly in accordance with a first embodiment of the present invention;

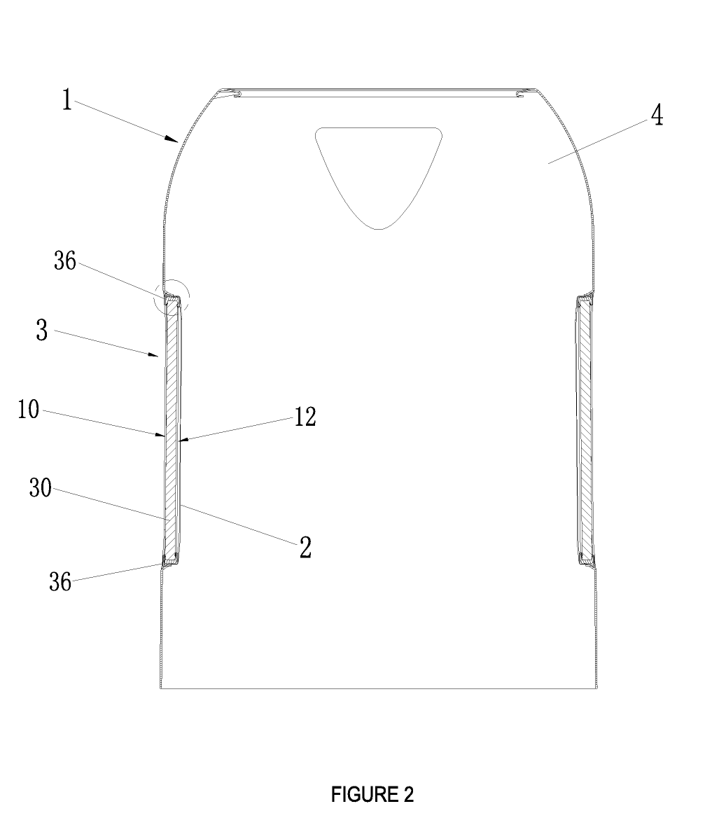

FIG. 2 is a cross-sectional view showing the kettle of FIG. 1;

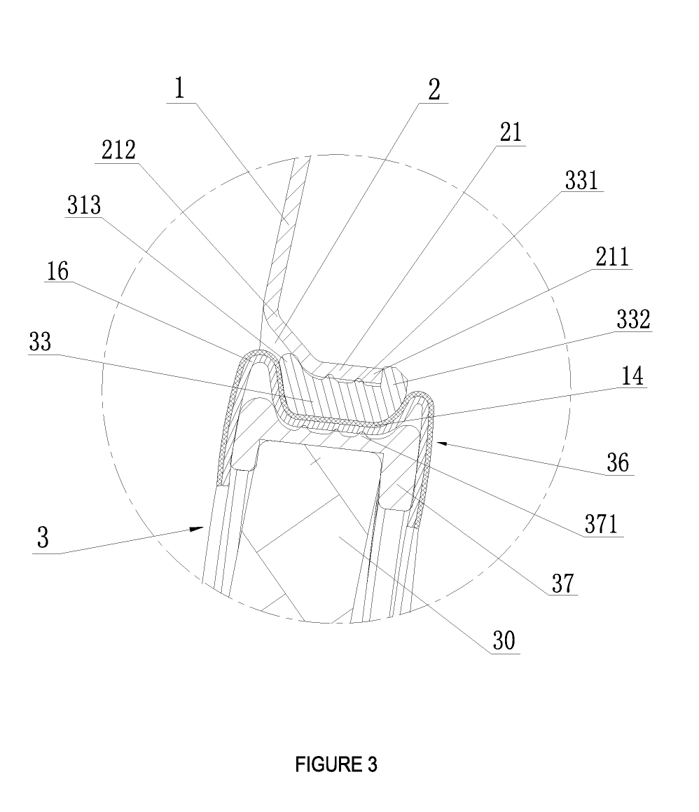

FIG. 3 is a magnified view of the area indicated by the circle of FIG. 2;

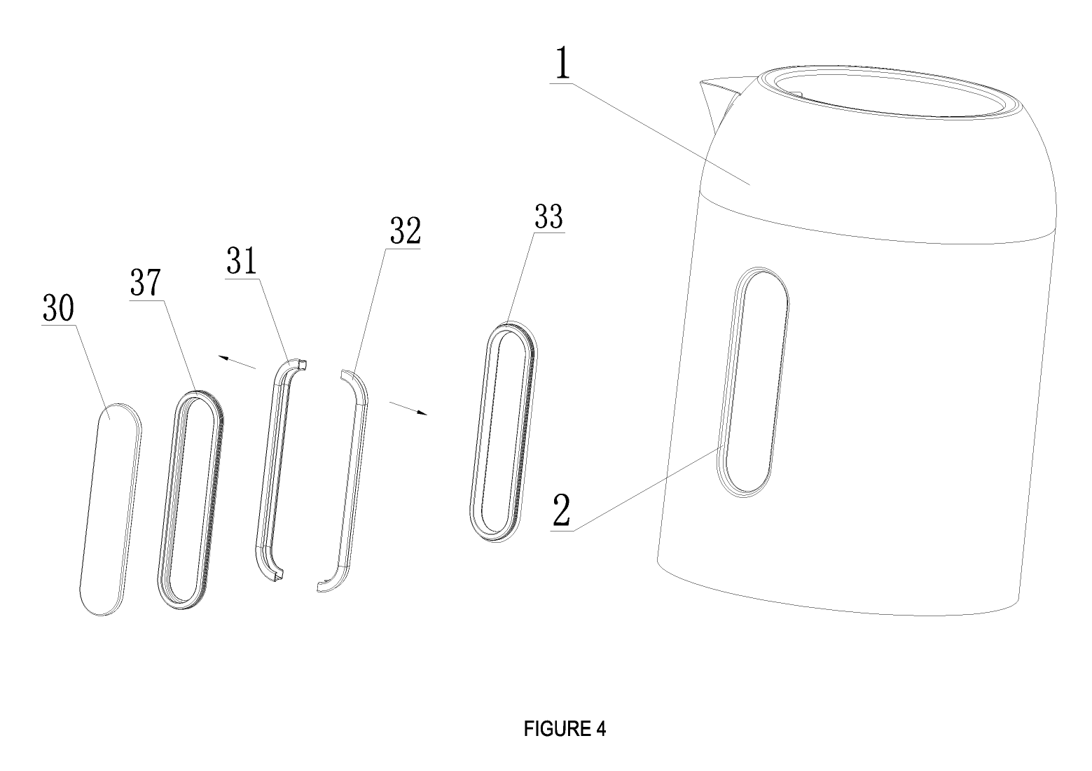

FIG. 4 is an exploded view of the window assembly of FIG. 1;

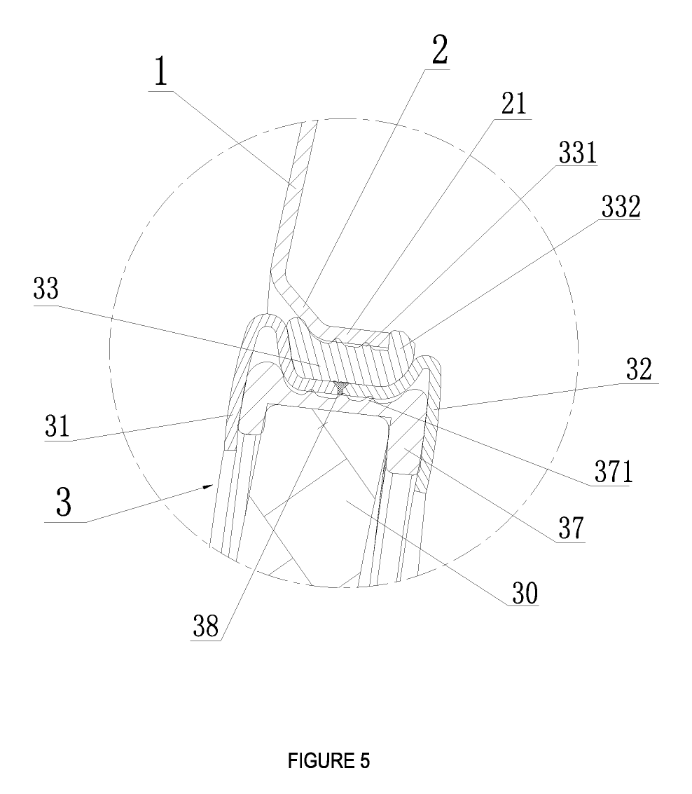

FIG. 5 is a magnified view of an area of a window assembly in accordance with a second embodiment of the present invention;

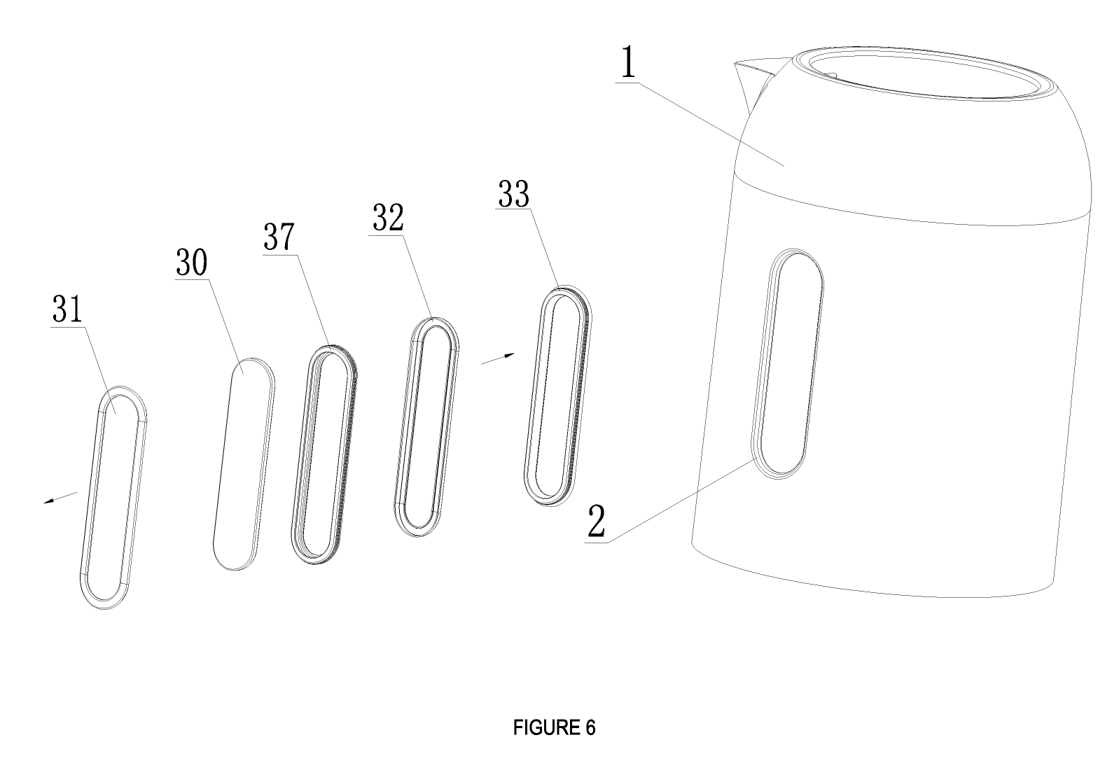

FIG. 6 is an exploded view of the window assembly of FIG. 5;

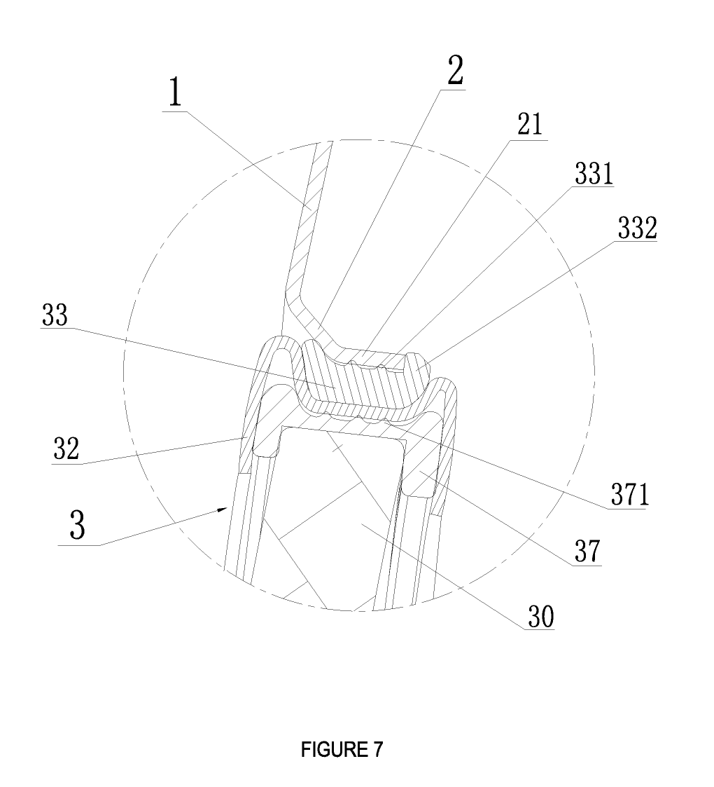

FIG. 7 is a magnified view of an area of a window assembly in accordance with a third embodiment of the present invention;

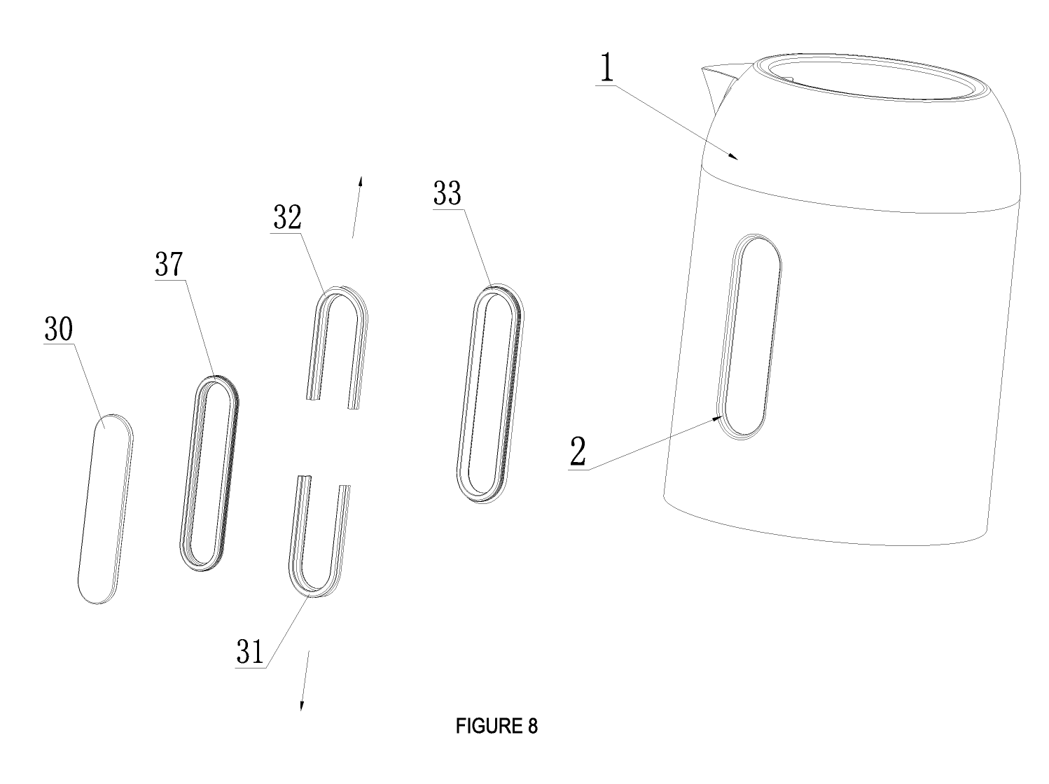

FIG. 8 is an exploded view of the window assembly of FIG. 7;

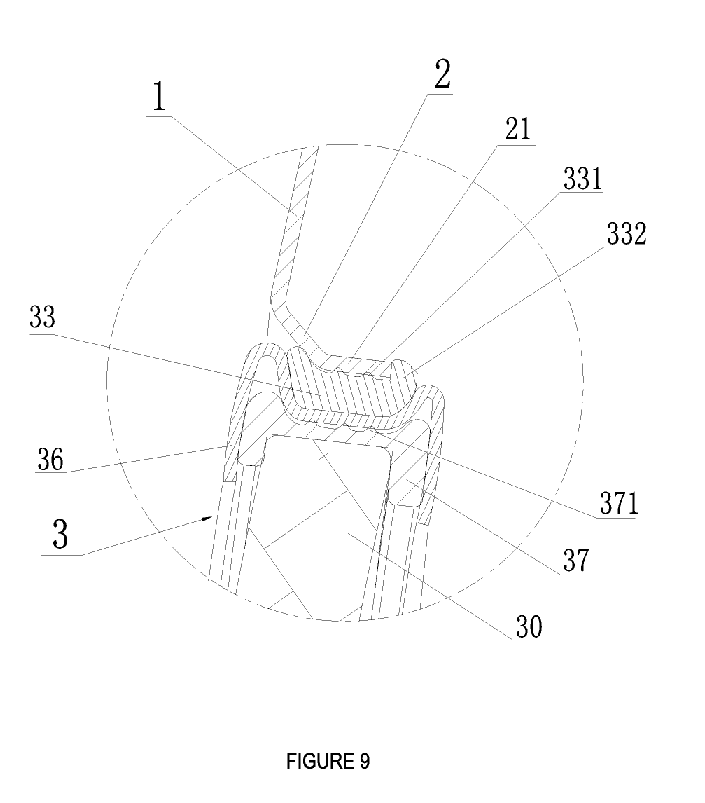

FIG. 9 is a magnified view of an area of a window assembly in accordance with a fourth embodiment of the present invention;

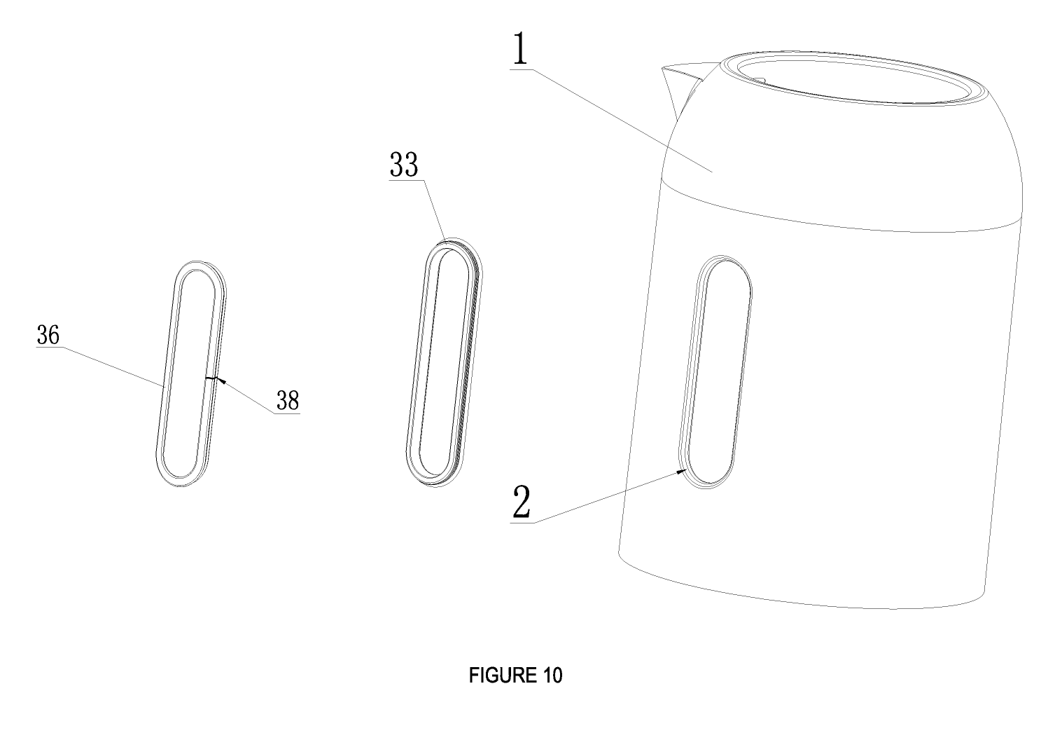

FIG. 10 is an exploded view of the window assembly of FIG. 9;

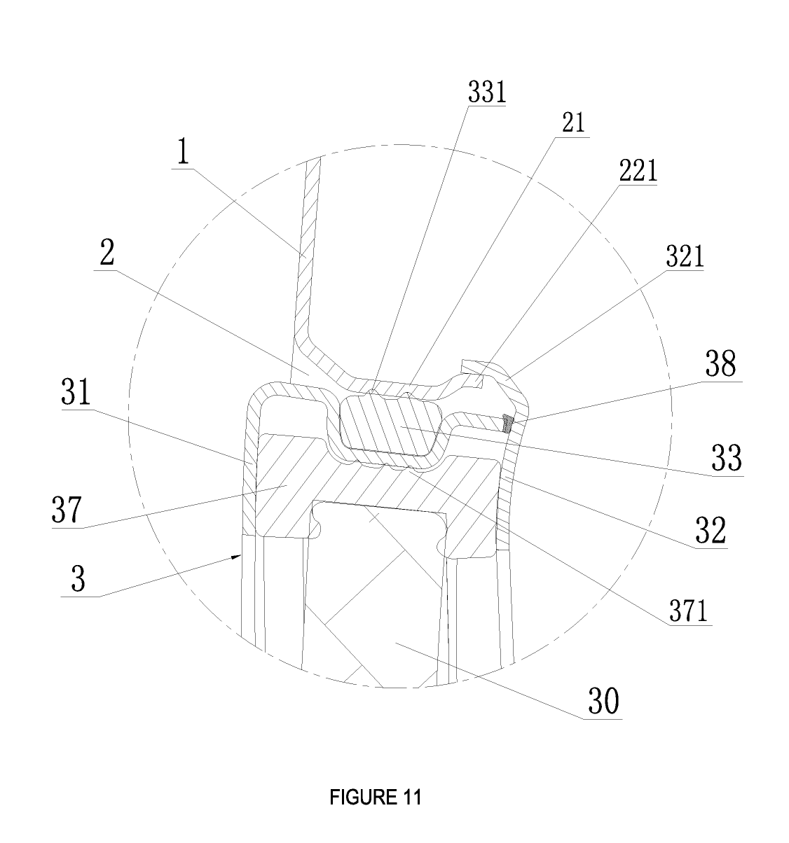

FIG. 11 is a magnified view of an area of a window assembly in accordance with a fifth embodiment of the present invention;

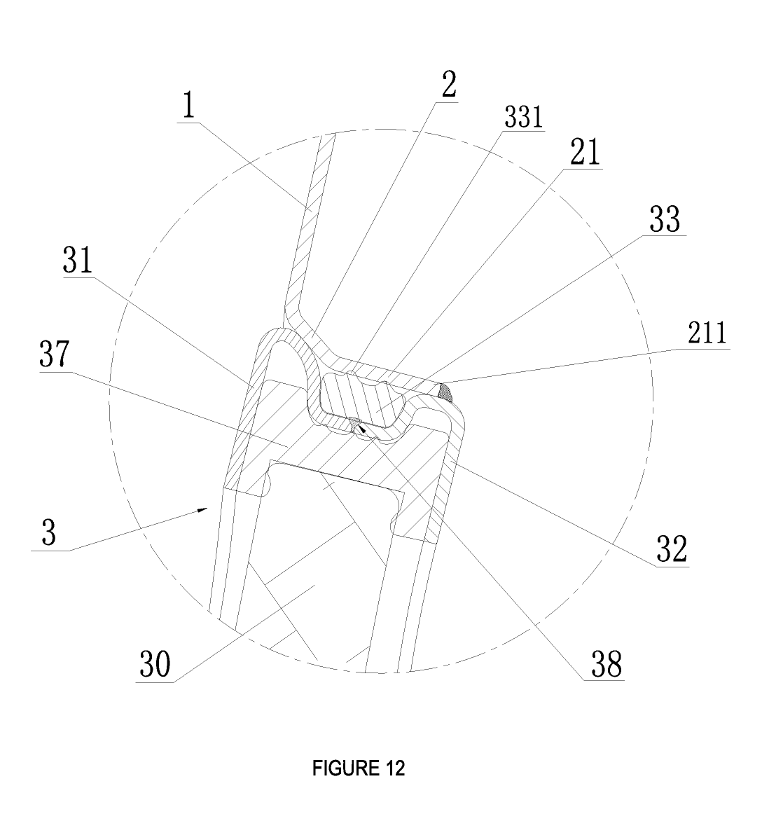

FIG. 12 is a magnified view of an area of a window assembly in accordance with a sixth embodiment of the present invention;

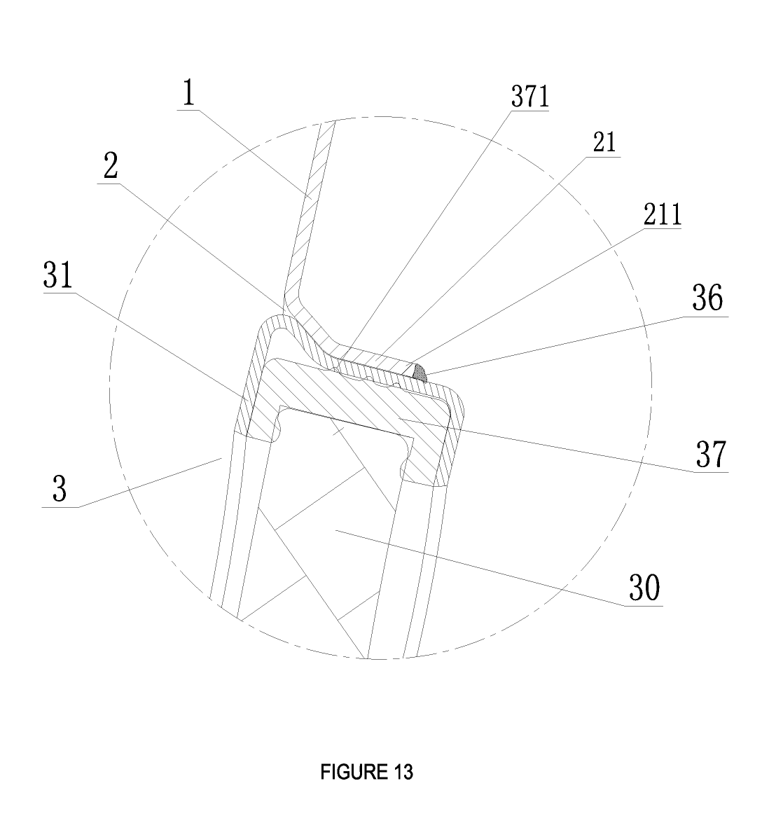

FIG. 13 is a magnified view of an area of a window assembly in accordance with a seventh embodiment of the present invention;

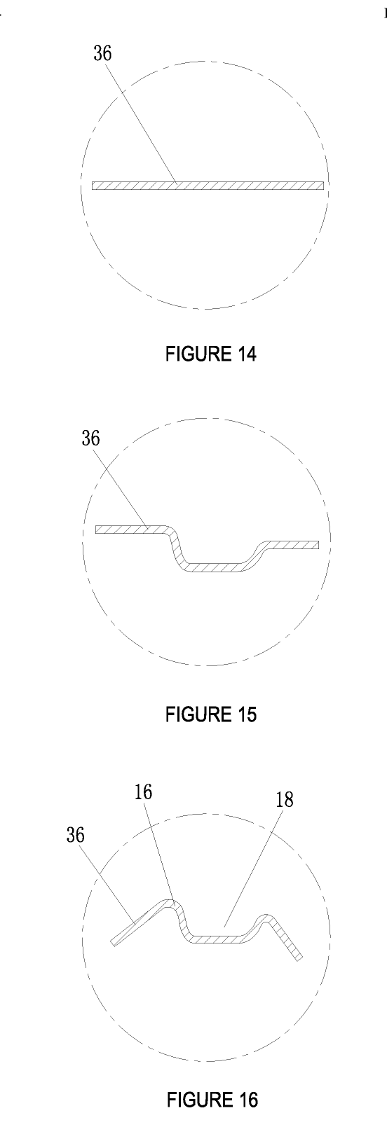

FIG. 14 shows the first step of preparing a frame member of the window assembly according to an embodiment of the present invention;

FIG. 15 shows the second step of preparing the frame member of the window assembly according to an embodiment of the present invention;

FIG. 16 shows the third step of preparing the frame member of the window assembly according to an embodiment of the present invention;

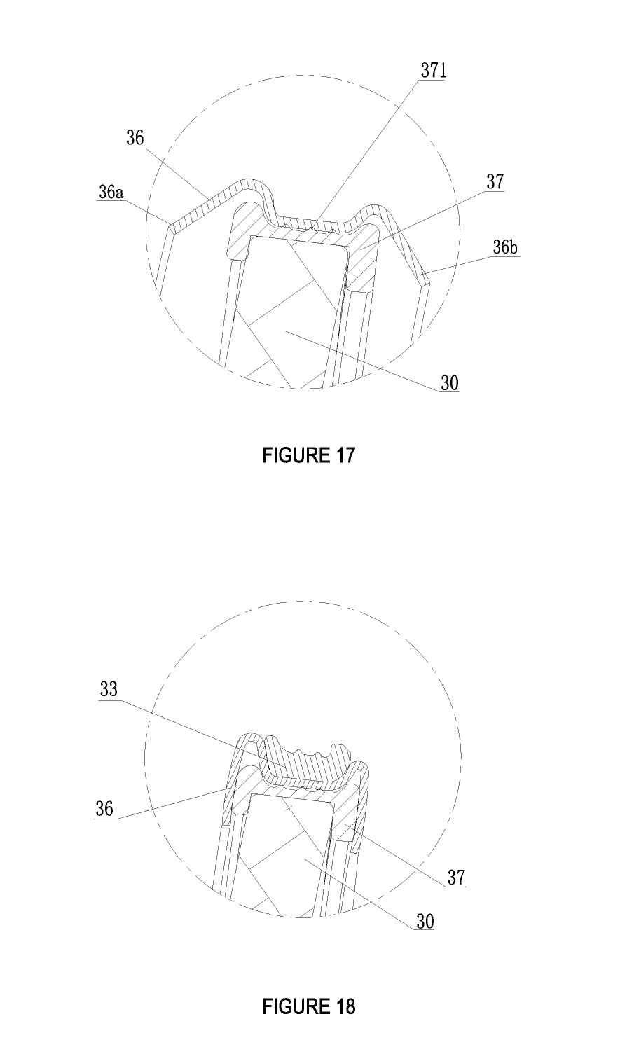

FIG. 17 shows the first step of arranging the frame member around a window of the window assembly according to an embodiment of the present invention;

FIG. 18 shows the second step of arranging the frame member around a window of the window assembly according to an embodiment of the present invention;

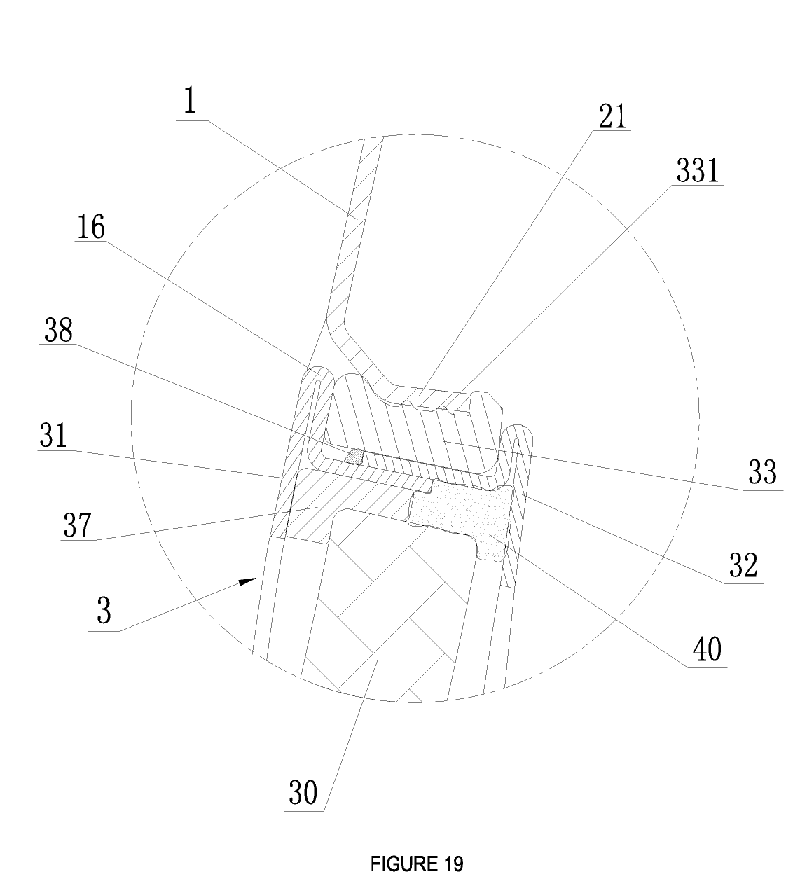

FIG. 19 is a magnified view of an area of a window assembly in accordance with a eighth embodiment of the present invention; and

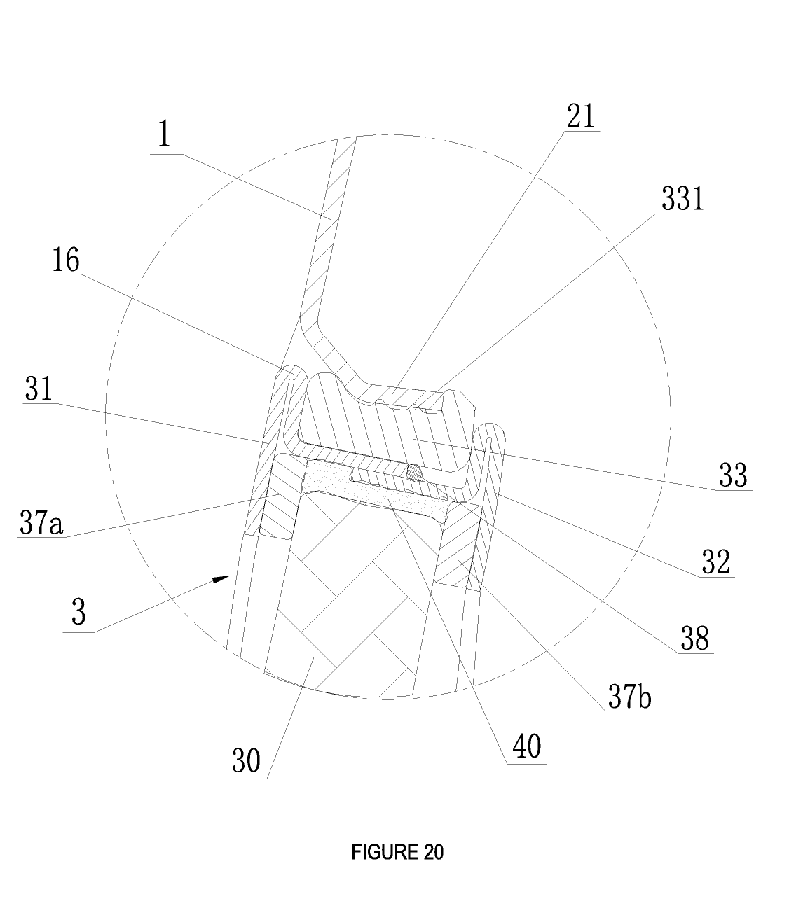

FIG. 20 is a magnified view of an area of a window assembly in accordance with a ninth embodiment of the present invention.

### MODE FOR THE INVENTION

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

A first embodiment of the present invention is illustrated in FIGS. 1 to 4. Specifically, FIG. 1 shows an electrical container 1 such as a kettle having a window assembly 3 inserted into a wall of the container body 4. The window assembly 3 comprises a window unit 5 adapted to be inserted into a window opening 2 of the container body 4. As shown in FIG. 2, the window unit 5 has an outer facing side 10 and an inner facing side 12 relative to the container 1, i.e. the outer facing side 10 being the side of the window unit 5 which faces the outside the container 1, and that the inner facing side 12 being the side of the window unit 5 which faces the inside the container 1 when the window unit 5 is assembled with the container 1. In this embodiment, the window unit 5 further comprises a window 30 and a frame member 36 which circumferentially surrounds the window 30.

As shown in more clearly in FIG. 3, the window unit 5 comprises a profiled circumferential edge 14, with a portion of the circumferential edge 14 adjacent the outer facing side 10 having a rising ridge 16 which acts to directly or indirectly limit the extent of insertion of the window unit 5 into the window opening 2, i.e. to prevent or reduce the chance of the window unit 5 being pushed through the window opening 2 or inserted too far into the window opening 2. The rising ridge 16 allows the outer facing side 10 of the window unit 5 to have a relatively larger dimension than that of the window opening 2, thereby limiting the amount of insertion of the window unit 5 into the window opening 2 after the rising ridge 16 is made to abut, directly or indirectly, a positioning portion at the window opening 2. In the embodiment as shown in FIG. 3, this positioning portion is in the form of an inwardly extending flange 21 depending inwardly towards the interior of container 1. The flange 21 may include a chamfered portion 212 against which the rising ridge 16 directly or indirectly abuts. In FIG. 3, it can be seen that the rising ridge 16 indirectly abuts the chamfered portion 212 of the flange 21 through bulged part 333 of a first resilient seal 33 to thereby provide a forward stopping means to limit insertion of the window unit into the window opening. The rising ridge 16 enables the window unit 5 to stay in place at the window opening 2 and to limit any further movement of the window unit 5 towards the container 1 through the window opening, so that the outer facing side 10 can be made to lie substantially flush or nearly flush with an outer surface of the body wall of the container 1.

The profiled circumferential edge 14 of the window unit 5 is adapted to receive the resilient first seal 33 which is arranged to circumferentially surround the window unit 5 and acts to seal a connection formed between the circumferential edge 14 of the window unit 5 and the window opening 2. In the embodiment as shown in FIG. 3, a recess is provided at the profiled circumferential edge 14 to accommodate the first seal 33. The first seal 33 is also adapted to cooperate with the rising ridge 16 to further limit the movement of the window unit 5 at the window opening 2 as described above. For example, by means of the frictional engagement between the first seal 33 and the flange 21 and/or the profiled edge 14, the window unit 5 can be more securely fitted at the window opening 2. The first seal 33 may further be provided with a profiled surface 331 to enhance the frictional effect at the contacts, or a bulge 332 to act against the flange end 211 to prevent the window unit 5 from coming away from the window opening 2, i.e. to act as a back stopping means helping to hold the window unit in place once assembled with the container. The first seal 33 may also assist in absorbing any stress built up at the connections.

Preferably, a second seal 37 can be arranged between the frame member 36 and the window 30 of the window unit 5 to allow sealing of the connection between the window 30 and an inner surface of the frame member 36 and also to absorb any stress concentrations at this connection. The second seal 37 may be provided with a profiled surface 371 to enhance the frictional engagement at one or more of its contact surfaces with the window 30 and the frame member 36. The second seal 37 also works cooperatively with the frame member 36 to enable a higher tolerance of the size of the window 30 with respect to the window opening 2, especially when the window 30 is made of a rigid material such as glass which is preferred to windows formed of plastics materials.

The frame member 36 can be made of materials such as metals, metal compounds such as metal alloys, polymers or a mixture thereof. The window 30 can be made of materials such as glass, ceramics, stones, polymers and a mixture thereof.

Although embodiments having a window unit 5 with an oval-shaped window 30 surrounded by a profiled frame member 36 are exemplified in the present invention, it is possible for the window unit 5 of the present invention to be configured in any shape, and/or as an integral unit, such as in the form of a window 30 with a profiled circumferential edge without being encased by a separate frame member 36 having a circumferentially profiled edge. For example, the window 30 can be made of a rigid polymer such as polycarbonate on which forming, cutting or machining of the window 30 to form a profiled circumferential edge is possible. It is also apparent that the window 30 can be configured into any shape other than the embodied oval shape so as to meet the aesthetic or functional requirements, as desired.

FIG. 4 shows an exploded view of the window assembly 3 of FIG. 3. Specifically, the frame member 36 comprises two frame units 31, 32, each of which is configured into a semi-oval shape adapted to surround the window 30 from the left and the right sides of the window 30. The two semi-oval shaped frame units 31, 32 can then be joined together at their junctions at the top and the bottom by any known connecting means in the field, for example, by adhesives, welding or a mechanical snap fitting arrangement.

FIGS. 5 and 6 illustrate another embodiment of the present invention in which the frame member 36 comprises two circular frame units 31, 32 adapted to frame the window 30 by sandwiching it from the front and the rear sides of the window 30. The two circular frame units 31, 32 can then be joined together at the junction 38 by means of, for example, glue or welding.

FIGS. 7 and 8 illustrate a further embodiment in which the frame member 36 comprises two U-shaped frame units 31, 32 adapted to surround the window 30 from the top and the bottom sides of the window 30.

FIGS. 9 and 10 illustrate yet a further embodiment of the present invention in which the frame member 36 is in the form of an integral, oval-shaped ring having a gap at the ring. After the ring is arranged to surround the window 30, the gap is then joined together by glue or welding.

FIG. 11 shows a further embodiment of the window assembly 3 of the present invention. In this embodiment, the frame member 36 comprises a first frame unit 31 profiled to receive the first seal 33. The frame member 36 further comprises a second frame unit 32 having a resilient arm 321. Specifically, the frame units 31 and 32 are arranged to surround the window 30, with a portion of the frame unit 31 adapted to attach with an inner surface of the frame unit 32 in a way that allows an end of the frame unit 32 to extend away from the junction 38 to form the flexing, resilient arm 321. During assembly, when the window unit 5 with the frame units 31, 32 is inserted into the window opening 2, the resilient arm 321 will first be compressed by the flange 21 to a collapsed state which allows the window unit 5 to advance through the window opening 2. After the window unit 5 is substantially inserted into the opening 2 and that the compression by the flange 21 is removed, the resilient arm 321 will be allowed to flex upward and thus catch the flange end 211 of the flange 21. Together with the frictional engagement between the first seal 33 and the flange 21, the arm 321 assists in limiting movement and thus insertion of the window unit 5 at the window opening 2, and preventing the window unit 5 from coming away from the window opening 2.

FIG. 12 shows another embodiment of the window assembly 3 in which the flange end 211 is fixedly attached to the frame unit 32 of the frame member 36 by, for example, glue or welding. The gluing or welding can be conducted after the window assembly 5 is inserted into the window opening 2. FIG. 13 illustrates a further embodiment having a similar construction, with the flange end 211 fixedly attached to the frame member 36. However, in this embodiment, no first seal 33 has been incorporated between the frame member 36 and the flange 21.

Referring to FIGS. 14 to 16, the steps of preparing the profiled edge 14 of the frame member 36 are illustrated. Specifically, a resilient, planar material such as a metal sheet or stripe is folded or stamped to provide the profiled surface 14 including the rising ridge 16 and a recess 18 adapted to receive the first seal 33. The metal sheet or stripe can then be bended along its length to form the semi-oval shaped frame units 31, 32, or a circular frame member 36. The two longitudinal ends of the frame units 31, 32 or the fame member 36 can then be joined together by, for example, welding to form a complete ring to circumferentially encase the window 30. FIGS. 17 and 18 further illustrate the steps of arranging the profiled frame member 36 to surround the circumferential edge of the window 30. Preferably, the second seal 37 is provided around the window 30 prior to the framing of the window 30 by the frame member 36. After the frame member 36 is arranged to surround the window 36, the two edges 36a, 36b of the frame member 36 will be folded or pressed inward against the window 30 so as to circumferential encase the window 30.

Optionally, an adhesive 40 can be further introduced between the frame member 36 and the window 30 as shown in FIGS. 19 and 20. Specifically, the adhesive 40 can be provided at at least one side of the window 30 adjacent to the second seal 37 (see FIG. 19), or adjacent the circumferential edge of the window 30 in between two second seals 37a, 37b (see FIG. 20). The adhesive 40 assists to provide an improved stress absorption, to allow higher tolerance of the window 30 with the frame member 36, and also to enhance the fixing between the window 30 and the frame member 36.

The present invention also provides a method of assembling a window assembly 3 into a window opening 2 of a container 1. Specifically, the assembling is conducted by inserting the window assembly 3 into the window opening 2. The method comprises the step of providing a window unit 5 having an outer facing side 10, an inner facing side 12 and a profiled circumferential edge 14, with a portion of the circumferential edge 14 adjacent the outer facing side 10 comprises a rising ridge 16. The method also comprises the step of inserting the inner facing side 12 of the window unit 5 into the window opening 2 so that the movement and thus the amount of insertion of the window unit 5 into the window opening 2 are limited by the rising ridge 16. Preferably, the inserting step is conducted via snap-fitting of the window unit 5 into the window opening 2. The profiled circumferential edge 14 is adapted to receive a first seal 33 which circumferentially surrounds the window unit 5 and acts to seal a connection formed between the circumferential edge 14 of the window unit 5 and the window opening 2.

Preferably, the step of providing the window unit 5 comprises the step of arranging a frame member 36 to circumferentially surround a window 30 to form the window unit 5, wherein the frame member 36 comprises the profiled circumferential edge 14. Preferably, a second seal 37 can be positioned between the frame member 36 and the window 30, and to surround the window 30. The first seal 33 and the second seal 37 are adapted to enable sealing of the connections, absorbing stress built up, and also limiting movement of the window unit 5 at the window opening 2, thereby providing a secure fitting and fixing of the window assembly 3 at the opening 2 of the container body 4.

The present invention is advantageous in that it provides a window assembly for a container which can be assembled with simple procedures and be manufactured at low costs.

It is appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations.

1. A window assembly for a container, comprising:
a window unit adapted to be inserted in a window opening of a container body, the window unit comprising an outer facing side, an inner facing side and a frame member arranged to circumferentially surround a window, wherein the frame member comprises the profiled circumferential edge, wherein a portion of the circumferential edge adjacent the outer facing side comprises a rising ridge which acts to limit insertion of the window unit into the window opening; wherein the profiled circumferential edge of the window unit is adapted to receive a first seal which circumferentially surrounds the window unit and acts to seal a connection formed between the circumferential edge of the window unit and the window opening; and wherein the first seal cooperates with the rising ridge to limit movement of the window unit at the window opening.

2. (canceled)

3. (canceled)

4. The window assembly according to claim 1, wherein the outer facing side of the window unit is of a relatively larger dimension than that of the window opening.

5. The window assembly according to claim 1, wherein the first seal is resilient.

6. The window assembly according to claim 1, wherein the first seal comprises a profiled surface.

7. (canceled)

8. The window assembly according to claim 1, wherein a second seal is arranged between the frame member and the window.

9. The window assembly according to claim 8, wherein an adhesive is arranged between the frame member and the window.

10. The window assembly according to claim 9, wherein the adhesive is arranged adjacent the second seal.

11. The window assembly according to claim 8, wherein the second seal comprises a profiled surface.

12. The window assembly according to claim 1, wherein the frame member comprises a plurality of frame units.

13. The window assembly according to claim 12, wherein the plurality of frame units are connected via welding.

14. A liquid container comprising a container body having a window opening adapted to receive a window assembly according to claim 1.

15. The liquid container according to claim 14, wherein the outer facing side of the window unit of the window assembly is of a relatively larger dimension than that of the window opening.

16. The liquid container according to claim 14, wherein the window opening comprises an inwardly extending flange with an end adapted to abut the first seal to limit movement of the window unit of the window assembly at the window opening.

17. A method of inserting a window assembly into a window opening of a container, comprising the steps of:
providing a window unit comprising an outer facing side, an inner facing side and a profiled circumferential edge with a portion of the circumferential edge adjacent the outer facing side comprising a rising ridge; and
inserting the inner facing side of the window unit into the window opening so that insertion of the window unit into the window opening is limited by the rising ridge.

18. The method of inserting a window assembly according to claim 17, wherein the profiled circumferential edge is adapted to receive a first seal which circumferentially surrounds the window unit and acts to seal a connection formed between the circumferential edge of the window unit and the window opening.

19. The method of inserting a window assembly according to claim 17, wherein the step of providing the window unit comprises step of arranging a frame member to circumferentially surround a window to form the window unit, wherein the frame member comprises the profiled circumferential edge.

20. The method of inserting a window assembly according to claim 19, further comprising the step of introducing a second seal between the frame member and the window.

21. The method of inserting a window assembly according to claim 19, further comprising the step of introducing an adhesive between the frame member and the window.

22. The method of inserting a window assembly according to claim 17, wherein the inserting step comprises the step of snap-fitting the window unit into the window opening.

23. The method of inserting a window assembly according to claim 17, wherein the step of arranging the frame member comprises the step of connecting a plurality of frame units to form the frame member, and wherein the step of connecting comprises welding.

24. (canceled)
